(19) United States
(12) Patent Application Publication
(10) Pub. No.: US 2015/0371567 A1
(43) Pub. Date: Dec. 24, 2015

(54) Apparatus and Method for Merchandising a Product

(71) Applicant: Kusin & Kusin, Ltd., Dallas, TX (US)

(72) Inventors: Eric Kaufman Kusin, Dallas, TX (US); Benjamin Brody Kusin, Dallas, TX (US); Scott Alan Hoffheiser, Dallas, TX (US)

(21) Appl. No.: 14/311,996

(22) Filed: Jun. 23, 2014

(51) Int. Cl. G09F 7/18

(52) U.S. Cl. CPC G09F 7/18; G09F 2007/1873

(57) ABSTRACT

A novel merchandising display apparatus and method presents small packaged products in a linear arrangement such as a column, a row or curved path, each package separated by a space containing a portion of a narrative about the product and its uses. The sequence of narrative portions tells a complete, concise story about the product in small phrases, one between each product package, to motivate the prospective customer to purchase it. The display apparatus may be supported in a variety of ways, for example on a stand or hung from a hook or a peg or other receptacle.

### BACKGROUND OF THE INVENTION

1. Field of the Invention

The present invention generally relates to merchandising displays and more particularly to an arrangement of displayed products that includes narrative information about the products in a display of product samples.

2. Background of the Invention and Description of the Prior Art

Products offered for sale in a retail store are typically arranged in a display that enables a prospective customer to view the product, perhaps even pick one up for a closer look or to take to a check out counter for purchase. The display may be designed with attractive graphics or brief statements of information such as price, principle feature or benefit, an encouragement to buy, etc. A wide variety of product display devices and methods are known, many of which are the subject of patent disclosures. The following brief descriptions represent several examples of the state of the art.

U.S. Pat. No. 7,448,497, Muchin, et al. depicts a hanging vertical display strip that packages a plurality of batteries, one below the other. Each of the batteries, which may be identical, has a graphic outer surface that may be distinguishable from the graphic on other batteries. The package includes apertures to facilitate rotation of the batteries to view the graphics thereon. However, this reference does not provide a narrative sequence about the product.

U.S. Pat. No. 7,243,796, Grablick, discloses a hangable vertical display strip supporting a plurality of products on adhesive patches along the strip to permit removal of the product. Each product may have indicia including graphics or text. This reference also does not disclose a narrative sequence about the product.

U.S. Pat. No. 1,689,637, Mordecai, discloses an advertising device configured as a pamphlet with a container of product samples attached to an inside surface of a cover of the pamphlet. The pamphlet includes pages having an opening at the location of the container. Descriptive text about the product is printed on pages of the pamphlet. This device must be handled, opened up, and manipulated to obtain the information and is not susceptible to viewing as displayed. International Patent Publication No. WO 02/14174, Gallagher, et al. , discloses story text next to free product samples in an advertising medium configured as a book, a comic book, or a trading card for entertaining prospective purchasers. The the intent of the device is to entertain and educate while making free samples of the product available to a prospective customer. However, this entertainment device or medium does not present a narrative sequence about the product interspersed with a plurality of product units for sale.

U.S. Patent Application Publication No. 2008/0037244, Hawkins, et al. discloses a vertical array of light bulb clusters—that are part of a lighting strand or string such as Christmas lights—supported on a narrow, hollow stand that contains the electrical supply conductors within it. The bulb clusters alternate with indicia cards that include statements about the bulb finish or the type of lighting strand being displayed.

When merchandising for sale small, packaged products that have a particular and novel function that can benefit from a narrative about the product and its uses, especially in differing circumstances, a display of the product should fulfill the need to explain to prospective buyers why they should be interested in the product, for example, at a particular time and place. For a product that lends itself to impulse buying and therefore placement at a retail checkout counter or other point of sale, where counter space or shelf space is very limited, a display must be designed with a small footprint. The prior art includes displays that are vertically arranged, but none are configured to present the product along with a narrative sequence about the product and its uses in a clear, dramatic way that does not require handling of the display.

### SUMMARY OF THE INVENTION

Accordingly there is disclosed herein a novel merchandising display apparatus and method that, in one embodiment, presents small packaged products in a vertical arrangement having a small footprint, and that arranges the product packages in a column (or row, in an embodiment having a horizontal arrangement), each package separated by a space containing a portion of a narrative about the product and its uses. The sequence of narrative portions collectively tells a complete story about the product in small, bite-sized statements, one between each product package, that is designed to motivate the prospective customer to reach for a product and purchase it. The display apparatus may be supported in a variety of ways, for example on a stand or hung from a hook or a peg or other receptacle.

### BRIEF DESCRIPTION OF THE DRAWINGS

FIG. 1 illustrates one embodiment of the present invention, with products installed;

FIG. 2 illustrates an alternate embodiment of the invention, shown without products;

FIG. 3 illustrates a table of possible narrative sequences keyed to areas marked on the alternate embodiment of FIG. 2:

FIG. 4 illustrates detail of a product support device used on the embodiment of FIG. 1;

FIG. 5 illustrates a detail of products supported on the embodiment of FIG. 4; and

FIG. 6 illustrates a side view of an embodiment similar to FIG. 1.

### DETAILED DESCRIPTION OF THE INVENTION

In an advance in the state of the art of merchandising displays, a novel merchandising display apparatus and method that presents, in one embodiment, small packaged products in a vertical arrangement having a small footprint is described. The device arranges the product packages in a column or row, each package—or group of packages hung on the same hook, for example—separated by a space containing a portion of a narrative about the product and its uses. The sequence of narrative portions, for example from top to bottom or side-to-side, collectively provides a complete but succinct, motivating narrative about the product in small, bite-sized statements, one between each product package. Thus, the invention presents a merchandising display, typically installed at a point of sale location, to present a narrative sequence about the product interspersed with a plurality of product units that also provides an inventory of the product offered for sale. The narrative is designed to motivate the prospective customer to reach for a product and purchase it. The display apparatus may, for example, be supported on a stand, or hung from a hook, peg, or other fixture, perhaps even along the edge of a shelf (if the display is horizontally disposed), near the point of sale.

The appended drawings illustrate one embodiment of the present invention. The structural features of the invention are identified by reference numbers. Depiction of the same structural feature in successive figures identify the same feature. Other embodiments—configurations or arrangements of the components of the merchandising display that embody the concepts disclosed herein—are contemplated.

In the following illustrative description, the merchandising display 10 supports a plurality of product embodiments, each packaged in a packet that may be hung or clipped to the substrate 12 of the display 10. The substrate 12 (or substrate member 12) may include hooks or clips 30 that permit multiple packets to be hung or clipped thereon. Thus, each hook or clip 30 may support a group of the product embodiments, which groups are referred to by the reference numbers 62, 64, 66 in this description. The reference numbers 62, 64, 66 may, in some alternate examples of the present invention, refer to individual product items that may or may not be packaged in packets but are otherwise adapted to be hung, clipped, or otherwise supported on the merchandising display 10 described herein. For example, the products may be packaged in articles that include but are not limited to bubble packs, blister packs, shrink wraps, small cartons, envelopes, lift tab containers, reclosable packets, small sacks, and the like.

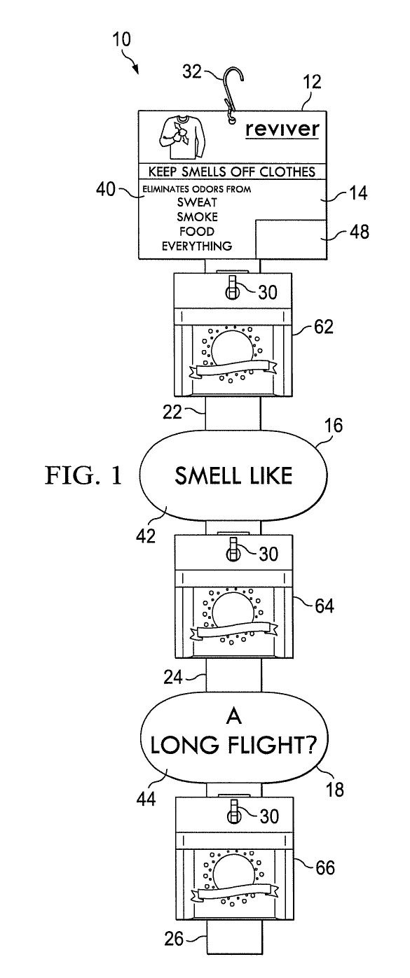

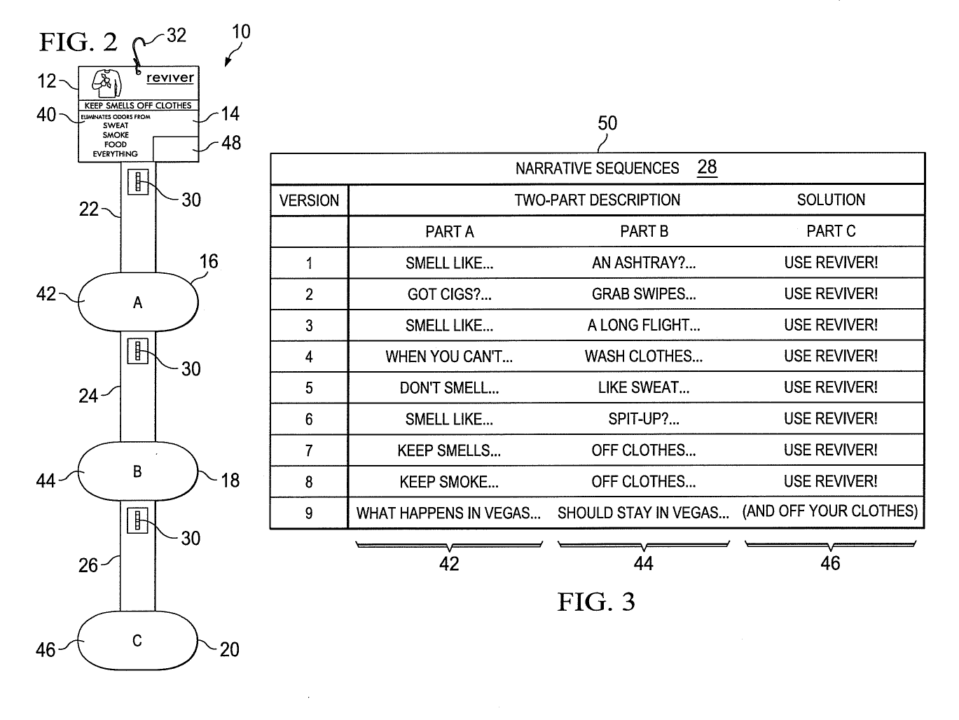

FIG. 1 illustrates one embodiment of the present invention, with products installed. The merchandising display/strip/fixture (“display”) 10 is depicted in an exemplary form with products 62, 64, 66 shown installed at intervals on hooks or clips 30 disposed along the substrate member 12. The substrate 12, typically formed as an elongated or linear array of shapes, may be fabricated from a single thin sheet of heavy paper, poster board, plastic or metal, and the like, and shaped, in this example, similar to the embodiment shown in FIG. 2. The substrate 12 may include designated regions in descending order such as a first header panel or message panel 14 at the upper end of the substrate 12, second message panel 16, third message panel 18, and product spaces 22, 24, and 26. The first, second, and third message panels 14, 16, and 18 may include graphics and/or text information about the products 62, 64, 66 that may be supported (hung, clipped, etc.) on the hooks or clips 30 positioned near the upper end of the product spaces 22, 24, 26, etc.

In the example depicted in FIG. 1, the first header panel or message panel 14 of the substrate 12 includes graphics and text that name the product, cite an important attribute, advantages of use, etc. The second 16 and third 18 message panels include brief statements of one kind of commonly occurring situation encountered by travelers. The second message panel 16 states the first phrase of a question: SMELL LIKE and the third message panel 18 states the second (and, in this example, the last) phrase of the question: A LONG FLIGHT?. These message panels supply, in a narrative sequence, a motivation for using the product displayed on the display 10. The narrative sequence identifies a condition often experienced by travelers in ready juxtaposition with a stock of the product that conveniently provides a solution to the condition. The narrative sequence of the phrases 42, 44 (in this example, but may include an additional phrase 46 as shown in FIGS. 2 and 3), may be collectively identified by the reference number 28 herein, as in “narrative sequence 28.” The stock of the product is shown in groups of packets 62, 64, 66 disposed on the hooks or clips 30 along the substrate 12. Each of the hooks or clips 30 may support more than one product or product group 62, 64, 66. The merchandising display 10 may itself be supported on a hook, peg or other similar device by placing the hole 34 on or over the hook or peg 32. While the hook 32 is shown for this purpose, it is representative of a variety of such devices as pegs, nails, strings, etc. that may be used to support the merchandising display 10 by means of the hole 34.

The present invention is susceptible to configuration other than in a vertical array, including linear (including curved or circular) arrays disposed at horizontal or other angles. In any linear array that may be devised to implement the concept embodied in the present invention, a header message panel disposed at a head position of the support member for identifying the product brand, function or benefit, and applications of use. The head position, i.e., header panel 14, may be at one end of the substrate 12 or in a central location along the linear array.

FIG. 2 illustrates an alternate embodiment of FIG. 1 without products attached, to show the single display as it may appear following fabrication from the thin substrate material. The fabrication may includes steps of die cutting, imprinting with the graphics and text, and in some cases attaching or installing the hooks or clips 30 to the substrate 12. FIG. 2 thus depicts one embodiment of the substrate 12, the hook supports 30 for the product packages, and the intervening message panels 16, 18, 20 between the product spaces 22, 24, 26. The intervening spaces are also labeled A, B, C, etc. to represent that the text statements to be printed (or otherwise affixed thereto) on them are placed in sequence along the display 10. Some illustrative options for the sequential, narrative statements that appear in the message panels 16, 18, 20 (respectively A, B, and C) are shown in FIG. 3 to be described. The observant reader will note that the merchandising display 10 depicted in FIGS. 2 and 3 includes three message panels 16, 18, 20 whereas the display 10 shown in FIG. 1 includes only two message panels 16, 18. These are two preferred embodiments of the present invention. Further, persons skilled in the art will recognize that many variations of the invention are possible. This suggests that the invention may be adapted to a variety of retail circumstances and placements.

FIG. 3 illustrates a table 50 of possible but not limiting narrative sequences 28 keyed to the areas A, B, and C marked on the alternate embodiment of FIG. 2. The illustrated narrative sequences 28 are presented in three part statements Part A (for message panel 42) states a first premise that refers to a typical problem that clothing or other surfaces are susceptible to. Part B (for message panel 44) states a particular aspect or symptom of the problem referred to by Part A. Part C (for message panel 46) then states the solution is to use the product displayed on the merchandising device to correct the problem described in Parts A and B. For example, in version #1 (in the first row of the table 50) the statement reads: SMELL LIKE . . . an ASHTRAY? . . . (then, by implication) USE REVIVER! The clear meaning is to ask the question of the customer perusing the product display 10: do your clothes smell like an ashtray? Then, if so, use the product Reviver (that is readily at hand on the merchandising display (or device) 10. Thus, the merchandising device 10 presents both a succinct message conveyed in narrative fashion along with an opportunity to reach for a product to solve the problem referred to in the narrative sequence 28 right on the display 10 that supports product packages 62, 64, 66 awaiting the customer's decision to try one. Similarly, the other text statements or phrases shown in the table 50 of FIG. 3 offer other examples or versions (See rows 2 through 9) of the kind of narrative sequence that may be conveniently provided by the merchandising display 10. It is just like having a sales person stand before the customer at the point of sale, for example, and holding up samples of the product, identifying the product, perhaps stating what it is, giving an example of its use, and offering to hand one of the packages to the customer who assents to the opportunity to buy the product.

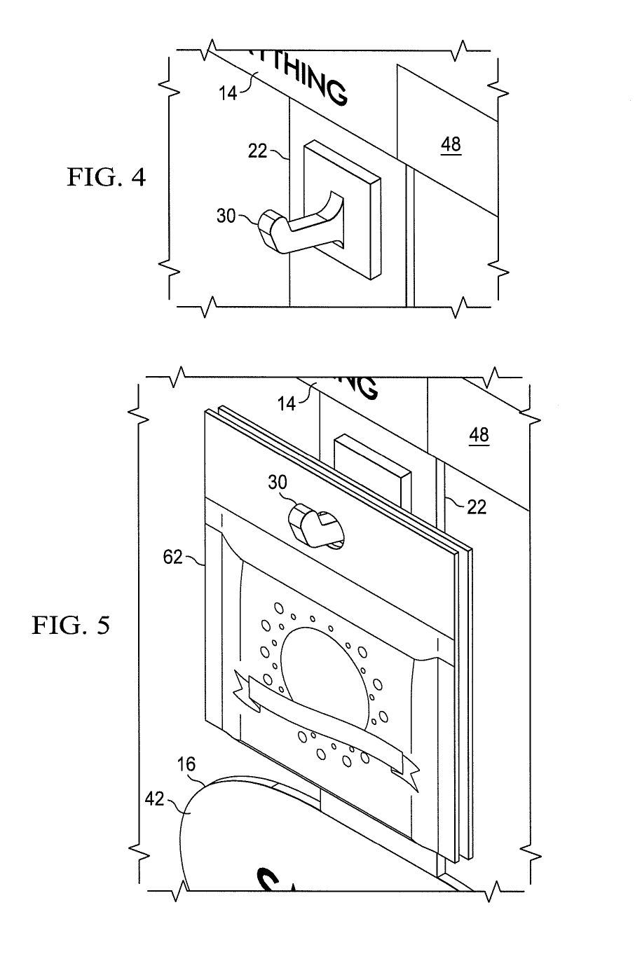

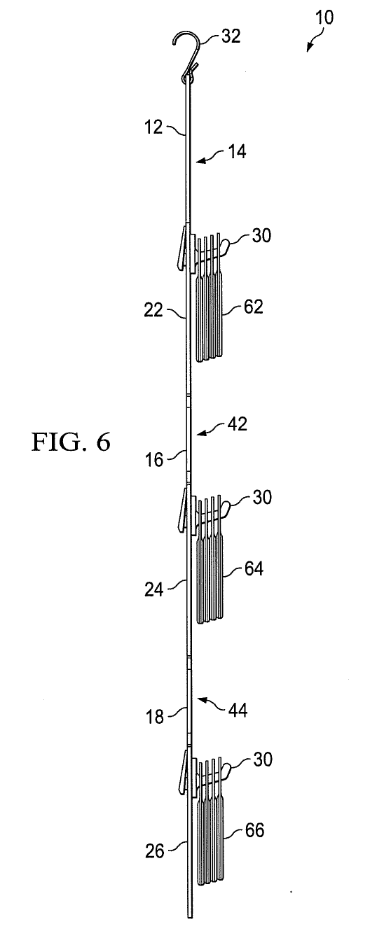

FIG. 4 illustrates detail of the substrate 12 and hook or clip 30 used on the embodiment of FIG. 1. The hook or clip 30 may for example be a molded plastic component that is affixed to the substrate 12 (also called a support member 12 herein) by adhesive means (not shown) or by inserting a mechanical feature 34 (See FIG. 6) molded into the backside of the hook or clip 30 into a corresponding receptacle feature 36 formed into the substrate 12. The receptacle feature 36 may typically be a cut out portion of the substrate 12 as indicated in FIG. 6. Alternative hooks or clips 30, or other types of mechanical devices may be fabricated of materials and by means well known in the art. The mechanical devices may comprise at least one device formed in or on the substrate 12 and selected from the group consisting of hooks, clips, pegs, and adhesive material, for example. Such devices are readily available from a variety of suppliers. Accordingly, the receptacle means may be fabricated to correspond with the hook or clip 30 selected for a particular embodiment or application of the merchandising display 10.

FIG. 5 illustrates a detail of several examples of product 62 supported on the section of the merchandising display 10 shown in FIG. 4.

FIG. 6 illustrates a side view of an embodiment of the merchandising display 10 similar to FIG. 1. In this view, a display 10 is fully stocked with packets of the product 62, 64, 66 upon the hooks of clips 30 affixed to the substrate 12. Although four packets are shown disposed on each of the hooks or clips 30, other quantities of packets of product 62, 64, 66 could be supported depending on the capacity of the hooks or clips 30. This also illustrates an edge-wise view of the manner in which the hooks or clips 30 of this embodiment are installed in the substrate 12, wherein a mechanical feature 34 molded into the backside of the hooks or clips 30 fits through a receptacle feature 36 formed into the substrate 12. The merchandising display 10 is shown with a hook 32 inserted in hole 34 of the substrate 12 for supporting the display 10 from a support (not shown, as it forms no part of the invention). The support may be a nail or peg or hook in a store fixture or a loop at the top of a stand, in turn supported on a counter top or shelf, for example.

While the invention has been shown in only one of its forms, it is not thus limited but is susceptible to various changes and modifications without departing from the spirit thereof. For example, although a single product example is illustrated in the figures, it is representative of any product that may be supported on a merchandising display strip along with a narrative sequence 28 of messages related to the product interposed with the products, regardless of scale or shape, color, design, etc. In another embodiment, the merchandising display 10 may be configured to be oriented horizontally, with the products and narrative sequence 28 message panels 16, 18, 20 disposed in a left-to-right (or right-to-left) sequence. Alternatively, the sequence of the sections of the merchandising display may be oriented at other angles besides the vertical or horizontal because the invention contemplates such alternate arrangements. In any linear array that may be devised to implement the concept embodied in the present invention, a header message panel disposed at a head position of the support member for identifying the product brand, function or benefit, and applications of use. As noted previously, the head position, i.e., header panel 14, may be at one end of the substrate 12 or in a central location along the linear array. In a typical case, the head position will be an uppermost position when the display apparatus is installed for use in a retail venue at a check out stand, for example. Still other arrangements may be implemented according to the concepts described herein, such as circular, curved paths, etc., as long as the products and message panels are arranged in a linear fashion such that the sequential disposition of the narrative sequence 28 is clear.

What is claimed is:

1. A merchandising apparatus, comprising:
a support member configured to support a plurality of products in a linear array, the products disposed individually or in groups separated by defined and substantially equal spaces;
a sequence of message panels, each message panel having information about the products and disposed in sequential order in successive spaces; wherein
successive ones of the message panels present a narrative sequence about the displayed product.

2. The apparatus of claim 1, wherein the support member comprises:
a substrate configured as a linear strip fabricated from a material selected from the group consisting of a single thin sheet of heavy paper, poster board, plastic, and metal; and
designated regions in a sequential order including a first head panel, and successive alternating product spaces and message panel spaces.

3. The apparatus of claim 1, wherein:
the narrative sequence includes a two-part description of a typical need and a third part stating a solution to the need, stated in terms of the product displayed.

4. The apparatus of claim 1, wherein:
the message panels and products are arranged in a sequence beginning with a head message panel, a first product, and at least one additional message panel and at least one additional product.

5. The apparatus of claim 1, wherein:
each message panel includes a graphic or text featuring at least one attribute of the product following the panel in the sequence.

6. The apparatus of claim 1, wherein:
the spaces may each include one or a group of products.

7. The apparatus of claim 1, wherein:
the products are supported by mechanical devices disposed on the support member within each of the spaces.

8. The apparatus of claim 7, wherein:
the mechanical devices comprise at least one device formed in or on the support member and selected from the group consisting of hooks, clips, pegs, and adhesive material.

9. The apparatus of claim 7, wherein:
the mechanical devices are attached to the support member as separate components.

10. The apparatus of claim 1, wherein the support member further comprises:
a header message panel disposed at a head position of the support member for identifying the product brand, function or benefit, and applications of use.

11. The apparatus of claim 1, wherein:
the narrative sequence includes graphic or pictorial features.

12. A method for merchandising a product, comprising the steps of:
providing a support member having a sequence of spaced-apart message panels with graphics disposed thereon directed to features of a product;
attaching at least one example of the featured product in a space disposed between each of the spaced-apart message panels; and
displaying the support member with the attached products in a prominent location.

13. The method of claim 12, comprising the step of:
arranging the panels and products in a sequence beginning with a head message panel, a first product, and at least one additional message panel and at least one additional product.

14. The method of claim 12, further comprising the step of:
attaching one or a group of products in each of the spaces.

15. The method of claim 12, further comprising the step of:
presenting a narrative message about the product in the sequence of message panels.

16. The method of claim 15, wherein:
the narrative message is selected from the group consisting of descriptions of features of the product, descriptions of advantages of the product, descriptions of the uses of the product, and motivational statements urging purchase of the product.

17. The method of claim 12, further comprising the step of:
supporting the products on a mechanical device selected from the group consisting of hooks, clips, pegs, strings, and adhesive devices disposed on each of the spaces on the support member.

18. A merchandising apparatus, comprising:
a support member configured to support a plurality of products in a linear array, the products disposed individually or in groups separated by defined and substantially equal spaces;
a sequence of message panels interposed in spaces between the products, each message panel having motivational information about the products; wherein
successive ones of the message panels present a narrative sequence to motivate purchase of the displayed product.

19. The apparatus of claim 18, wherein the support member comprises:
a substrate configured as a linear strip fabricated from a material selected from the group consisting of a single thin sheet of heavy paper, poster board, plastic, and metal; and
designated regions in a sequential order including a first head panel, and successive alternating product spaces and message panel spaces.

20. The apparatus of claim 18, wherein:
the narrative sequence includes a two-part description of a typical need and a third part stating a solution to the need, stated in terms of the product displayed.
